(19) United States
(12) Patent Application Publication
(10) Pub. No.: US 2008/0030464 A1
(43) Pub. Date: Feb. 7, 2008

(54) MOTION-BASED USER INTERFACE FOR HANDHELD

(76) Inventors: Mark Sohm, Waterloo (CA); Rob Bredin, Waterloo (CA); Kathryn Wilhelm, Waterloo (CA)

Correspondence Address: SMART AND BIGGAR, 438 UNIVERSITY AVENUE, SUITE 1500 BOX 111, TORONTO, ON, M5G2K8, CA

(21) Appl. No.: 11/832,748

(22) Filed: Aug. 2, 2007

Related U.S. Application Data
(60) Provisional application No. 60/821,326, filed on Aug. 3, 2006.

(51) Int. Cl. G06F 3/033

(52) U.S. Cl. 345/157

(57) ABSTRACT

A mobile wireless communications device is arranged to allow for the entry of a motion capture command from a user interface. After receiving such a command, the device generates a recorded motion from output signals from a motion sensor incorporated in the device. A user may then identify a particular contact record through the user interface whereupon the device will associate the contact with the recorded motion.

### CROSS-REFERENCE TO RELATED APPLICATIONS

The present application claims the benefit and priority from prior provisional application Ser. No. 60/821,326, filed Aug. 3, 3006, the contents of which are hereby incorporated herein by reference.

### COPYRIGHT NOTICE

A portion of the disclosure of this patent document contains material which is subject to copyright protection. The copyright owner has no objection to the facsimile reproduction by any one of the patent document or patent disclosure, as it appears in a Patent Office patent file or records, but otherwise reserves all copyright rights whatsoever.

### BACKGROUND

This relates to a motion-based user interface for a mobile wireless communications device.

A mobile wireless communications device typically has one or more of the following which serve as a user interface for the device: contact switches (at least some of which may be arrayed as keys on a keyboard), rocker switches, a thumb wheel, and a touch screen.

These typical user interfaces may be difficult to manage, especially where a user is occupied so as not to be able to look at the user interface, either at all or for longer than a brief time period.

Therefore, there remains a need for an improved user interface.

### BRIEF DESCRIPTION OF THE DRAWINGS

In the figures which illustrate example embodiments,

FIG. 1 is a front view of a mobile wireless communications device suitable for use with the described embodiments, and

FIG. 2 is a schematic view of the device of FIG. 1,

FIG. 2A is a block diagram of an exemplary contact record,

FIG. 3 is a flow diagram illustrating operation of the processor of the device of FIG. 1,

FIG. 4 is a schematic diagram illustrating a possible processing of a curve produced by the operation of FIG. 3,

FIGS. 5 and 6 are flow diagrams illustrating operation of the processor of the device of FIG. 1,

FIG. 7 is a screen shot of an exemplary e-mail composition screen, and

FIG. 8 is a flow diagram illustrating the operation of a processor of an alternative embodiment of the device.

### DETAILED DESCRIPTION

A mobile wireless communications device is arranged to allow for the entry of a motion capture command from a user interface. After receiving such a command, the device generates a recorded motion from output signals from a motion sensor incorporated in the device. A user may then identify a particular contact record through the user interface whereupon the device will associate the contact with the recorded motion.

Accordingly, there is provided a method for operating a mobile wireless communications device, comprising: after receipt of a motion capture command from a user interface, generating a recorded motion from output signals from a motion sensor; receiving an identification of a contact through said user interface; and associating said contact with said recorded motion.

In another aspect there is provided a mobile wireless communications device comprising: a motion sensor; a user interface; a memory for storing a plurality of contacts, a plurality of recorded motions and, for each recorded motion, an association between said each recorded motion and a contact of said plurality of contacts; a processor operatively connected to an output of said motion sensor and coupled for communication with said memory and with said user interface, said processor for: upon receipt of a motion capture command from said user interface, entering a motion capture mode; during said motion capture mode, generating a recorded motion from output signals from said motion sensor; receiving an identification of one contact of said plurality of contacts through said user interface; and storing in memory an association between said one contact and said recorded motion.

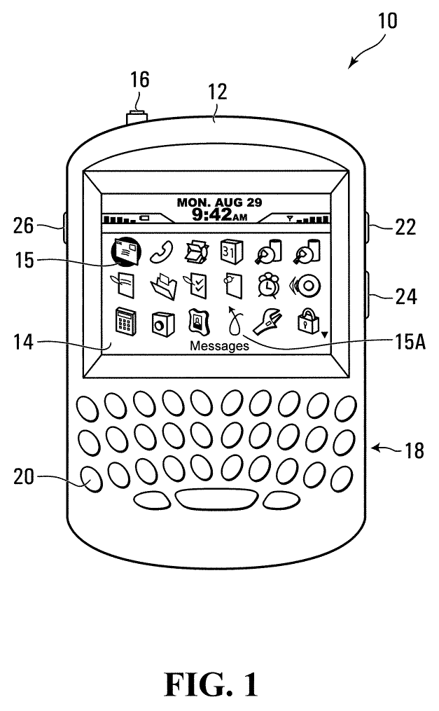

Turning to FIG. 1, mobile wireless communications device 10 may have a housing 12, a display 14, a camera 16, and a user interface 18 having a keyboard 20, a thumb wheel 22, an escape key 24, and a motion key 26. The display 14 may be a full graphic Liquid Crystal Display (LCD) and may display a number of icons 15 representative of available applications on the device.

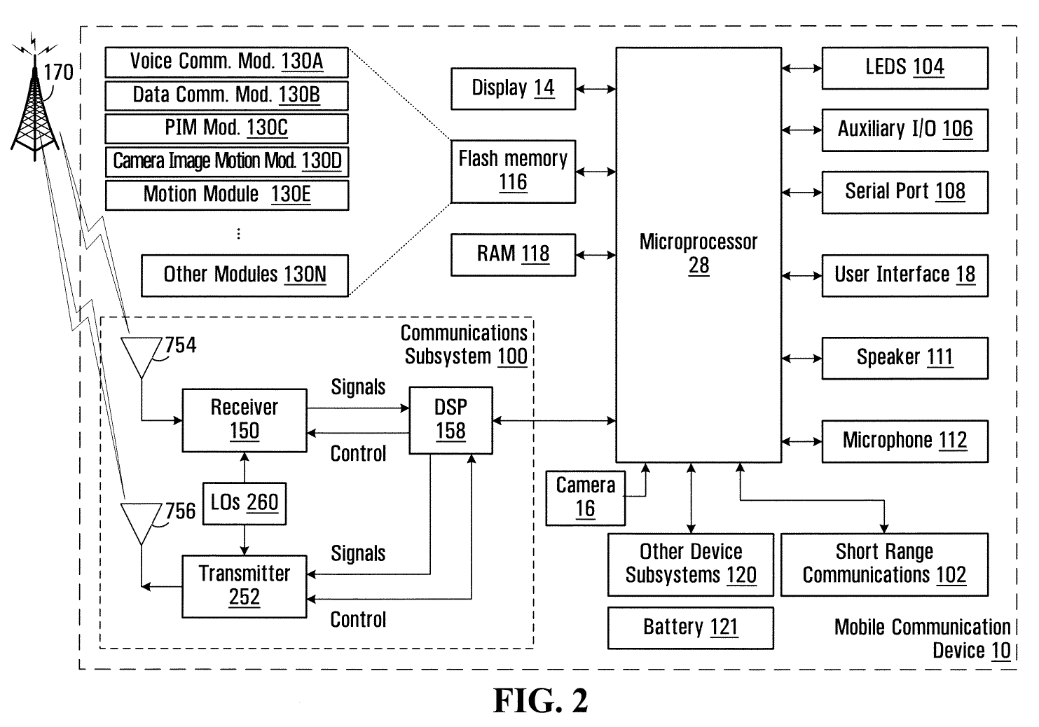

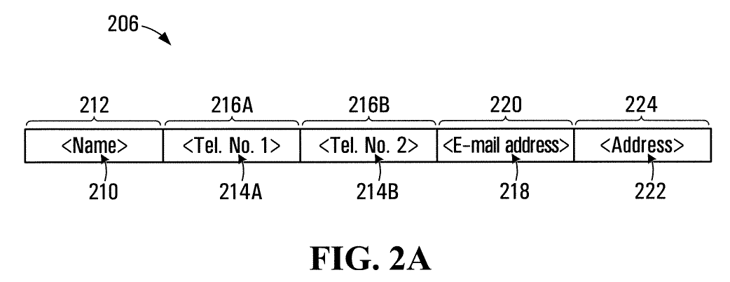

With reference to FIG. 2, a processing device (a microprocessor 28) is shown schematically as coupled between the user interface 18 and the display 14. The microprocessor 28 controls the operation of the display 16, as well as the overall operation of the mobile device 10, in response to the user interface.

The housing may be elongated vertically, or may take on other sizes and shapes (including clamshell housing structures). The keyboard may include a mode selection key, or other hardware or software for switching between text entry and telephony entry.

In addition to the microprocessor 28, other parts of the mobile device 10 are shown schematically in FIG. 2. These may include: a communications subsystem 100; a short-range communications subsystem 102; the user interface 18 and the display 14, along with other input/output devices including a set of auxiliary I/O devices 106, a serial port 108, camera 16 a speaker 111 and a microphone 112; as well as memory devices including a flash memory 116 and a Random Access Memory (RAM) 118; and various other device subsystems 120. The mobile device 10 may have a battery 121 to power the active elements of the mobile device 10. The mobile device 10 is preferably a two-way radio frequency (RF) communication device having voice and data communication capabilities. In addition, the mobile device 10 preferably has the capability to communicate with other computer systems via the Internet.

Operating system software executed by the microprocessor 28, is preferably stored in a persistent store, such as the flash memory 116, but may be stored in other types of memory devices, such as a read only memory (ROM) or similar storage element. In addition, system software, specific device applications, or parts thereof, may be temporarily loaded into a volatile store, such as the RAM 118. Communication signals received by the mobile device may also be stored to the RAM 118.

The microprocessor 28, in addition to its operating system functions, enables execution of software applications on the mobile device 10. A predetermined set of software applications that control basic device operations, such as a voice communications module 130A and a data communications module 130B, may be installed on the mobile device 10 during manufacture. In addition, a personal information manager (PIM) application module 130C may also be installed on the mobile device 10 during manufacture. The voice communication module 130A is responsible for presenting a user interface screen to allow establishment and termination of voice communications. The PIM application is preferably capable of organizing and managing data items, such as contacts, e-mail, calendar events, voice mails, appointments, and task items. The PIM application is also preferably capable of sending and receiving data items via a wireless network 170. In this regard, the PIM application is responsible for presenting user interface screens for displaying stored data items, such as contacts and e-mail, and for sending e-mail. Preferably, the data items managed by the PIM application are seamlessly integrated, synchronized and updated via the wireless network 170 with the device user's corresponding data items stored or associated with a host computer system. As well, a camera image motion module 130D and a motion module 130E may be installed on the mobile device 10 during manufacture. Additional software modules, illustrated as another software module 130N, may also be installed during manufacture.

Communication functions, including data and voice communications, are performed through the communication subsystem 100, and possibly through the short-range communications subsystem 102. The communication subsystem 100 includes a receiver 150, a transmitter 152 and one or more antennae, illustrated as a receive antenna 154 and a transmit antenna 156. In addition, the communication subsystem 100 also includes a processing module, such as a digital signal processor (DSP) 158, and local oscillators (LOs) 160. The specific design and implementation of the communication subsystem 100 is dependent upon the communication network in which the mobile device 10 is intended to operate. For example, the communication subsystem 100 of the mobile device 10 may be designed to operate with the Mobitex™, DataTAC™ or General Packet Radio Service (GPRS) mobile data communication networks and also designed to operate with any of a variety of voice communication networks, such as Advanced Mobile Phone Service (AMPS), Time Division Multiple Access (TDMA), Code Division Multiple Access CDMA, Personal Communications Service (PCS), Global System for Mobile Communications (GSM), etc. Other types of data and voice networks, both separate and integrated, may also be utilized with the mobile device 10.

Network access requirements vary depending upon the type of communication system. For example, in the Mobitex™ and DataTAC™ networks, mobile devices are registered on the network using a unique Personal Identification Number (PIN) associated with each device. In GPRS networks, however, network access is associated with a subscriber or user of a device. A GPRS device therefore requires a subscriber identity module, commonly referred to as a Subscriber Identity Module (SIM) card, in order to operate on a GPRS network.

When required network registration or activation procedures have been completed, the mobile device 10 may send and receive communication signals over the communication network 170. Signals received from the communication network 170 by the receive antenna 154 are routed to the receiver 150, which provides for signal amplification, frequency down conversion, filtering, channel selection, etc., and may also provide analog to digital conversion. Analog-to-digital conversion of the received signal allows the DSP 158 to perform more complex communication functions, such as demodulation and decoding. In a similar manner, signals to be transmitted to the network 170 are processed (e.g., modulated and encoded) by the DSP 158 and are then provided to the transmitter 152 for digital to analog conversion, frequency up conversion, filtering, amplification and transmission to the communication network 170 (or networks) via the transmit antenna 156.

In addition to processing communication signals, the DSP 158 provides for control of the receiver 150 and the transmitter 152. For example, gains applied to communication signals in the receiver 150 and the transmitter 152 may be adaptively controlled through automatic gain control algorithms implemented in the DSP 158.

In a data communication mode, a received signal, such as a text message or web page download, is processed by the communication subsystem 100 and is input to the microprocessor 28. The received signal is then further processed by the microprocessor 28 for an output to the display 14, or alternatively to some other auxiliary I/O devices 106. A device user may also compose data items, such as e-mail messages, using the keyboard 20 (FIG. 1) and other elements of the user interface 18. The composed data items may then be transmitted over the communication network 170 via the communication subsystem 100.

In a voice communication mode, overall operation of the device is substantially similar to the data communication mode, except that received signals are output to a speaker 111, and signals for transmission are generated by a microphone 112. Alternative voice or audio I/O subsystems, such as a voice message recording subsystem, may also be implemented on the device 10. In addition, the display 14 may also be utilized in voice communication mode, for example, to display the identity of a calling party, the duration of a voice call, or other voice call related information.

The short-range communications subsystem 102 enables communication between the mobile device 10 and other proximate systems or devices, which need not necessarily be similar devices. For example, the short-range communications subsystem may include an infrared device and associated circuits and components, or a Bluetooth™ communication module to provide for communication with similarly-enabled systems and devices.

The motion module 130E stored in flash memory 116 may include a motion recording application which captures a motion of device 10 and associates it with a particular contact stored in memory based on user inputs via user interface 18. FIG. 2A illustrates an exemplary contact record with a name 210 stored in a name field 212, telephone numbers 214a , 214b stored in telephone number fields 216a , 216b , an e-mail address 218 stored in an e-mail field 220, and an address 222 stored in an address field 224. Other exemplary contact records may have additional fields, such as fields for further e-mail addresses, fields for further telephone numbers, a field for a web address, and so on. Other exemplary contact records may also have a lesser number of fields, such as a field only for a name and a telephone number.

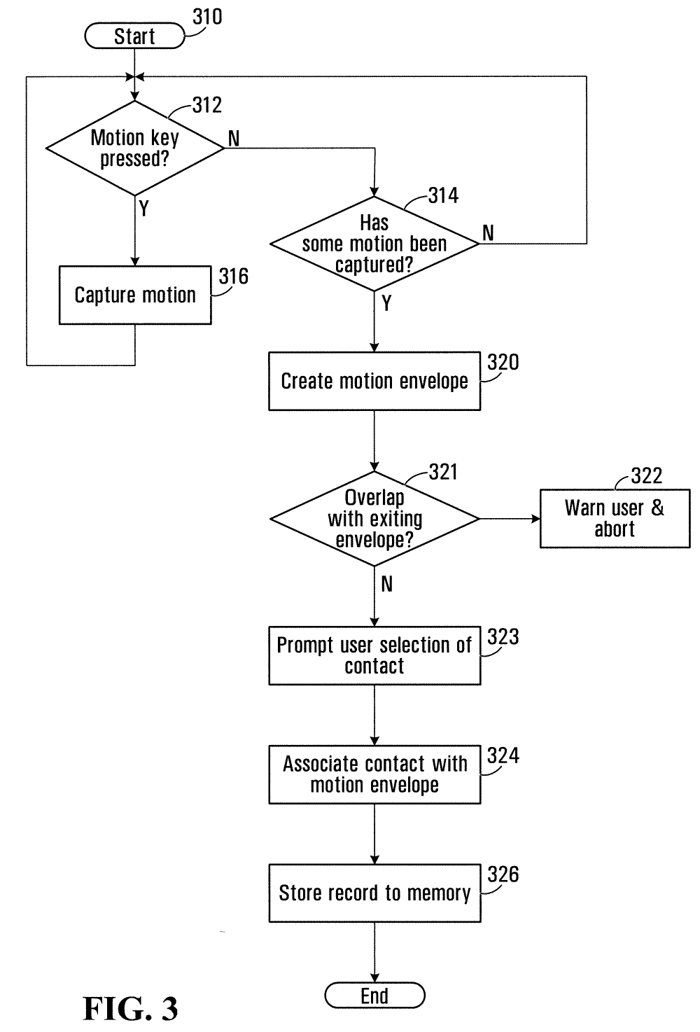

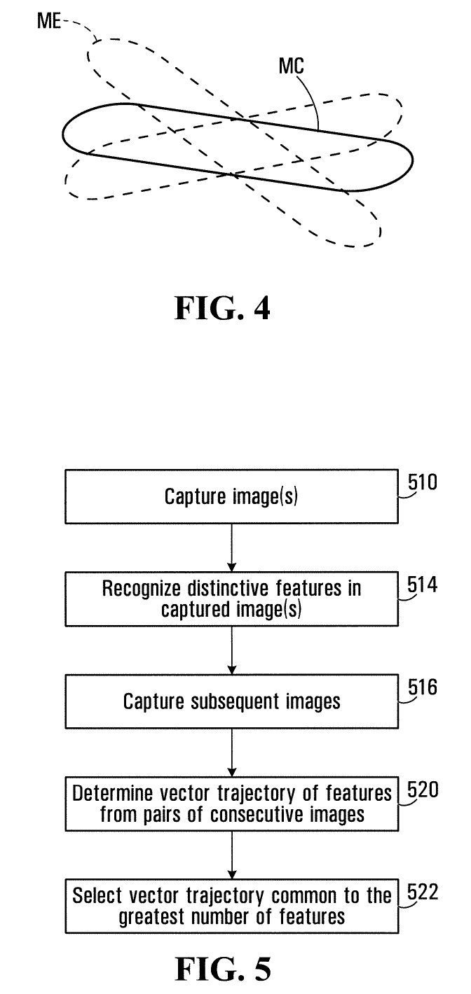

The motion recording application may be launched by processor 28 when a pre-defined command is entered via user interface 18. For example, display 14 may have motion recording icon 15A which, when selected, results in processor 28 undertaking the steps outlined in FIG. 3. Turning to FIG. 3, on launch (310), the processor waits until the motion key 26 (FIG. 1) is pressed (312, 314). Once this key is pressed, the processor captures subsequent motion of the device 10 (316) (as is described more fully hereafter) until key 26 is released. To enhance accuracy, optionally, a user could be required to input the motion plural times and an average taken as the captured motion. Once the motion key is released (314), the processor may create a motion envelope as the recorded motion (320). More specifically, the motion envelope may be a range of different motions centered about the captured motion. For example, with reference to FIG. 4, if the captured motion MC was a close-to-circular oval shape in a plane +3° from the horizontal, the motion envelope ME may encompass similar shapes from −7° to +13° from the horizontal. The processor then compares the motion envelope with any previously created motion envelope and if there is an overlap, such that one motion could be mistaken for the other (321), the processor warns the user and aborts the operation (322). Assuming there is no overlap with an existing motion envelope, the processor then prompts the user to select a contact via user interface 18 (323). This selected contact is associated with the motion envelope in memory, such as by creation of a record which is stored to memory (324, 326).

In this way, a user may, for example, associate a circle subscribed by device 10 in a horizontal plane with a particular contact.

FIG. 5 details the record motion step 316 of FIG. 3. Turning to FIG. 5, the processor captures an initial image, or set of images, from the camera 16 (510). Then (under control of camera image motion module 130D), the processor recognises a few distinctive features in the captured image(s) (514). A distinctive feature may be, for example, a circle, triangular, or rectangular shape in the image. The processor then captures subsequent images from the camera (516) and, where a given distinctive feature persists in the subsequent images, determines a vector trajectory for the given distinctive features from pairs of consecutive images (520). It may be expected that some of the features will be part of static background in the environment whereas others may be part of something moving in the environment. The static features will share the same, or a very similar, vector trajectory. Thus, the processor may select as the vector trajectory for device 10 that of the vector trajectory common to the greatest number of features (522). In this regard, a user may be instructed to point the camera toward static environment during motion capture to enhance the likelihood of capturing the true motion of the device 10.

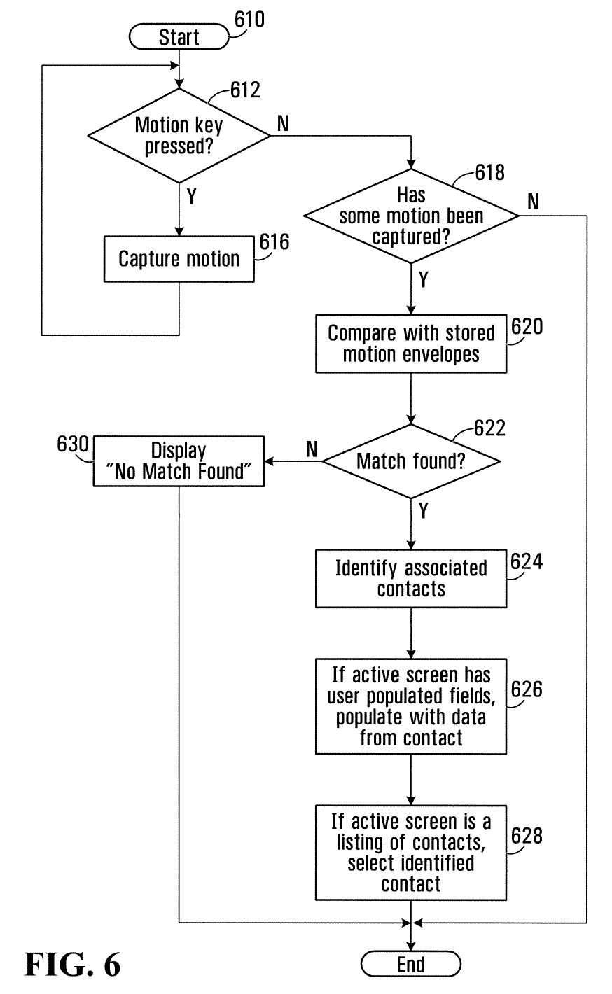

If, when the motion recording application has not been launched, the motion key 26 is pressed, motion module 130E may launch a motion replay application wherein a motion replay mode is entered, as detailed in FIG. 6. Turning to FIG. 6, after motion key 26 is pressed (612), the processor captures the motion of device 10 (616) in the same manner as described in conjunction with FIG. 5. After the motion key 26 is released, if some motion has been captured (618), this captured motion is compared with stored motion envelopes (620). On finding a match (622), the processor identifies the contact associated with the matching motion envelope (624). If the active screen of device 10 has user entry fields, the processor then populates these fields with data from any like fields of the associated contact (626). Alternatively, if the active screen of device 10 is a listing of contacts, the identified contact is highlighted on the screen as the active contact (628) such that further user input operates upon this active contact. If no match is found, the user is so informed (630), allowing the user to try again.

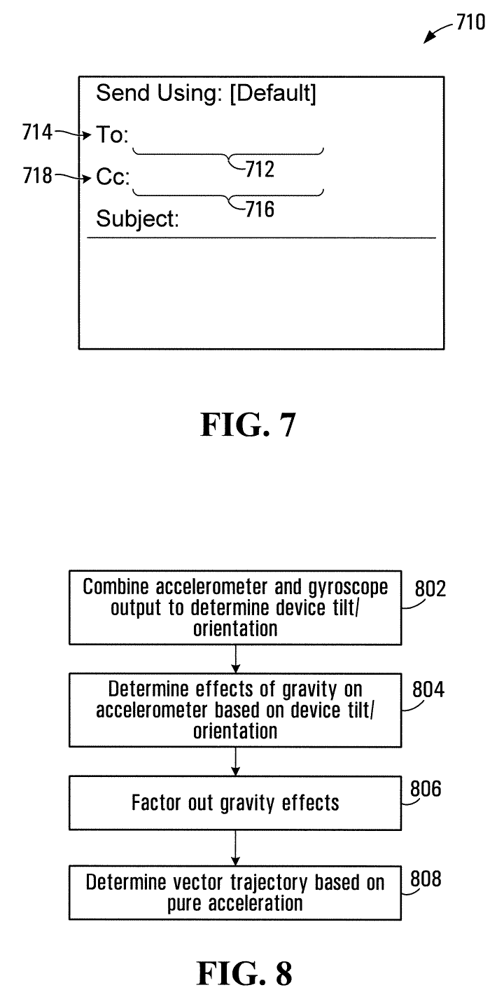

For example, a user, through the user interface 18, may select the email application of the PIM module 130C and then request the opening of an e-mail composition screen so that this is the active screen of the device 10: FIG. 7 illustrates an exemplary such screen. Turning to FIG. 7, e-mail composition screen 710 has a primary recipient field 712 headed with a “To:” label 714 and a cc recipient field 716 headed with a “Cc:” label 718. If, thereafter, the user presses the motion key 26 to enter the motion replay mode, the device will then capture its subsequent motion and the processor will compare this motion with the database of motion envelopes. On finding a match, the processor will retrieve the associated contact and extract the e-mail address 218 from the e-mail field 220. This extracted address will then be used to populate the first empty recipient field (712 or 716) in the e-mail composition screen 710. The user could repeat the process to populate the next empty recipient field.

As a further example, a user could select a telephone call initiation application of the voice communication module 130A. This may result in a display of a screen with a field for entry of a destination number. Through motion entry, the user may select a particular contact whereupon the processor will populate the destination number field with a telephone number from the identified contact record. In this regard, if the contact record stores more than one telephone number, the user may be asked to select between the stored numbers.

As another example, a user could select a word processing application of one of the other modules 130N and launch a blank screen of the word processing application as the active screen. Through motion entry, the user may select a particular contact whereupon the processor may port the name and address stored in the contact record to the blank document, formatted as an address for a letter. In this instance, the entire blank document may be considered as a user entry field.

From the foregoing, it will be apparent that the camera, in conjunction with the camera image motion module 130D, acts as a motion sensor. In other embodiments, a different motion sensor could be used. For example, a small electromechanical motion sensor could be used, such as the three axis MEMS motion sensor described in U.S. Pat. No. 6,504,385 to Hartwell et al., the contents of which are hereby incorporated herein by reference. Alternatively, one or more accelerometers or gyroscopes could be used individually or in combination.

For example, in one embodiment, the motion sensor may comprise a three-axis accelerometer and a gyroscope. In such an embodiment, the record motion step 316 of FIG. 3 could be as illustrated in FIG. 8. Referring to that figure, the output of the accelerometer and gyroscope may first be combined to determine the tilt or orientation of the device 10 (802). Based on the device orientation, the effects of gravity upon the accelerometer in each of the three axes may be determined (804). These effects may then be factored out of the accelerometer output in order to avoid any possible misinterpretation of gravity as acceleration (806). With the determined pure linear acceleration in each of the three axes, a vector trajectory for device 10 can be determined (808).

Rather than developing motion envelopes from captured motions, other techniques could be employed to compare captured motions with an input motion in a way which would accommodate user variability. For example, fuzzy logic could be used to “fuzzify” certain parameters of the captured motions.

Rather than using a motion key 26, motion recording and playback could be initiated from a selection menu accessed by user interface 18. In such instance, motion capture may be announced with a beep a short time after selection of motion recording to allow a user time to prepare to commence the motion. During motion capture, the processor may temporarily configure a key on user interface 18 as a hot key for use by the user to signal the end of motion capture. The same selection menu could be used to signal the beginning of motion playback and the same hot key used to signal the end of the motion playback. Since this approach requires that a user focus more attention on the user interface 18 when using motion entry, this approach is not preferred.

Other modifications will be apparent to those skilled in the art and, therefore, the embodiments are defined in the claims.

What is claimed is:

1. A method for operating a mobile wireless communications device, comprising:
after receipt of a motion capture command from a user interface, generating a recorded motion from output signals from a motion sensor;
receiving an identification of a contact through said user interface; and
associating said contact with said recorded motion.

2. The method of claim 1 wherein said contact comprises a stored record with a name field and at least one of a telephone number field and an email field.

3. The method of claim 2 further comprising:
after launch of a screen as an active screen responsive to a request from said user interface, upon sensing said recorded motion from output signals from said motion sensor, inputting information stored in said contact to user entry fields of said active screen.

4. The method of claim 3 further comprising monitoring for said recorded motion after receiving a motion replay command.

5. The method of claim 4 wherein said user interface comprises at least one switch and wherein said motion capture command comprises a switched signal from one or more of said at least one switch.

6. The method of claim 5 wherein said motion replay command comprises a switched signal from one or more of said at least one switch.

7. The method of claim 6 wherein said motion sensor output signals indicate a motion in three-dimensional space.

8. The method of claim 7 further comprising generating said motion sensor output signals based on a change of an image sensed by a camera.

9. The method of claim 2 further comprising:
after receipt of an email composition request from said user interface, displaying an email composition screen;
upon sensing said recorded motion from output signals from said motion sensor, inputting an email address stored in said contact in a recipient field of said email composition screen.

10. The method of claim 9 further comprising monitoring for said recorded motion after receiving a motion replay command.

11. The method of claim 2 further comprising:
after receipt of a contact display request from said user interface, displaying a list of contacts;
upon sensing said recorded motion from output signals from said motion sensor, selecting said contact from said list of contacts.

12. The method of claim 11 further comprising monitoring for said recorded motion after receiving a motion replay command.

13. The method of claim 2 further comprising:
after receipt of a telephone application request, displaying a telephone number entry screen;
upon sensing said recorded motion from output signals from said motion sensor, inputting a telephone number stored in said contact in a telephone number field of said telephone number entry screen.

14. The method of claim 13 further comprising monitoring for said recorded motion after receiving a motion replay command.

15. The method of claim 2 wherein said contact record further comprises an address field.

16. The method of claim 15 further comprising:
after receipt of a word processing request, displaying a blank document screen;
upon sensing said recorded motion from output signals from said motion sensor, inputting a name stored in said contact name field and an address stored in said address field to said blank document screen formatted as a recipient address for a letter.

17. A mobile wireless communications device comprising:
a motion sensor;
a user interface;
a memory for storing a plurality of contacts, a plurality of recorded motions and, for each recorded motion, an association between said each recorded motion and a contact of said plurality of contacts;
a processor operatively connected to an output of said motion sensor and coupled for communication with said memory and with said user interface, said processor for:
upon receipt of a motion capture command from said user interface, entering a motion capture mode;
during said motion capture mode, generating a recorded motion from output signals from said motion sensor;
receiving an identification of one contact of said plurality of contacts through said user interface; and
storing in memory an association between said one contact and said recorded motion.

18. The device of claim 17 wherein each of said plurality of contacts comprises a record with a name field and at least one of a telephone number field and an email field.

19. The device of claim 18 wherein said processor is further for:
after launching an active screen of an application responsive to a request from said user interface, upon sensing said recorded motion from output signals from said motion sensor, retrieving information stored in said contact and inputting said information to user entry fields of said active screen.

20. The device of claim 19 wherein said processor is further for monitoring for said recorded motion after receiving a motion replay command.
